(19) United States
(12) Patent Application Publication
(10) Pub. No.: US 2025/0299044 A1
(43) Pub. Date: Sep. 25, 2025

(54) METHOD AND SYSTEM FOR AUTOMATICALLY OPTIMIZING A VARIETY OF NEURAL NETWORK DESIGN PRINCIPLES IN PRODUCTION ENVIRONMENTS

(71) Applicant: SAMSUNG ELETRÔNICA DA AMAZÔNIA LTDA., MANAUS (BR)

(72) Inventors: ANDRÉ RAMOS FERNANDES DA SILVA, MANAUS (BR); LUIZ ALBERTO QUEIROZ CORDOVIL JÚNIOR, MANAUS (BR); RAYOL DE MENDONÇA NETO, MANAUS (BR); VANESSA DE SOUZA CAMARA, MANAUS (BR); LUÍS FELIPE UEBEL, MANAUS (BR)

(73) Assignee: SAMSUNG ELETRÔNICA DA AMAZÔNIA LTDA., MANAUS (BR)

(21) Appl. No.: 18/669,715

(22) Filed: May 21, 2024

(30) Foreign Application Priority Data
Mar. 22, 2024 (BR) 10 2024 005713 9

(51) Int. Cl. G06N 3/086; G06N 3/04

(52) U.S. Cl. CPC G06N 3/086; G06N 3/04

(57) ABSTRACT

The present invention relates to the automatic adaptation of deep neural networks to data and/or concept changes through a method that: reveals a variety of design principles (e.g., interconnection of learning blocks, network size, etc.) of deep neural networks for a variety of learning tasks (e.g. image and language processing). The method evolves neural networks constrained by discovered design principles; trains and validates neural networks; hosts a production environment where validated neural networks can operate on production data; monitors production data and network performance; reports different signs of obsolescence; and addresses signs of obsolescence by retraining neural networks with recent production data, replacing obsolete deep neural networks with new models designed by neural architecture research, and/or discovering new design principles to refactor the entire structure, which significantly improves the robustness of machine learning operations in production environments.

### CROSS-REFERENCE TO RELATED APPLICATION(S)

This application is based on and claims priority under 35 U.S.C. § 119 to Brazilian Patent Application No. BR 10 2024 005713 9, filed on Mar. 22, 2024, in the Brazilian Intellectual Property Office, the disclosure of which is incorporated by reference herein in its entirety.

### TECHNICAL FIELD

The present invention relates to the automatic adaptation of deep neural networks to data and/or concept changes through a method that: reveals a variety of design principles (e.g., interconnection of learning blocks, network size, etc.) of deep neural networks for a variety of learning tasks (e.g. image and language processing); evolve neural networks constrained by discovered design principles; trains and validates neural networks; hosts a production environment where validated neural networks can operate on production data; monitors production data and network performance; reports different signs of obsolescence; and addresses signs of obsolescence by retraining neural networks with recent production data, replacing obsolete deep neural networks with new models designed by neural architecture research, and/or discovering new design principles to refactor the entire structure, which significantly improves the robustness of machine learning operations in production environments.

### BACKGROUND OF THE INVENTION

Deep Neural Networks (DNN) have achieved impressive results in automating complex tasks such as computer vision (e.g. object recognition in real-time video streaming), natural language processing (e.g. natural language interfaces), analytics and time series forecasting (e.g. weather forecasting), health (e.g. cancer diagnosis) and others. They are also employed in modern controlled systems such as autonomous vehicles, stock trading bots, and Industry 4.0 smart factories.

Creating a next-generation DNN can require many trials (trial and error) in an iterative process to design the network architecture, optimize hyperparameters, and train and validate models. For example, machine learning engineers must choose and combine different types of learning units. Here, the term “learning unit” refers to any type of processor capable of learning from data, which may include, but are not limited to: perceptrons, artificial neurons, fully connected neural networks (FCNN), convolutional neural networks (CNN), recurrent neural networks (RNN), residual networks (ResNet), deep belief networks (DBNs) and others. Machine learning engineers must define activation functions, kernel sizes, number of neurons, and how these learning units will be combined and interconnected into an overall topology, as well as consider the training schedule, learning rates, regularization, and data improvement.

In order to automate this process, a variety of neural architecture search (NAS) methods have been proposed. Most NAS are based on evolutionary algorithms (e.g. genetic algorithms), but Reinforcement Learning and other optimization algorithms have also been employed.

Searching networks for NAS is generally an expensive process because it requires evaluating the performance of many candidate DNNs from a huge search space. Many proxy tasks have been proposed as cost-saving measures, such as training with a reduced schedule of a few epochs, training with only a fraction of training data, and others. Modern zero-cost performance predictors have also shown great promise due to the ability to predict the performance of a DNN without training, which significantly reduces the cost of the NAS.

Furthermore, this advanced technology could not be deployed in reliable and scalable applications without machine learning operations (MLOps), which comprises all software development and information technology automation (DevOps) operations, as well as other specific requirements for machine learning applications such as automatic deployment of validated models, performance monitoring, continuous recycling with fresh data, and/or automatic replacement of obsolete models.

Performance monitors are key components of modern MLOps pipelines because the world is constantly changing. For example, a data drift occurs when there is a significant change in the distribution of input data, such as data coming from new devices capable of producing more accurate data with better resolution and/or new functionality. Furthermore, a concept drift occurs when there is a significant change in the correlation between input data and output data, which may be caused by contextual changes that may require modification of the decision criteria operated by machine learning systems.

Both data drift and concept drift cause performance degradation in machine learning applications trained with stale data that is no longer representative of the current context. More advanced MLOps pipelines handle this with continuous recycling and/or automatic replacement of obsolete models. For example, a new DNN-designed by machine learning engineers or by NAS-could outperform a DNN in production and automatically replace it.

The paper entitled “Hidden Design Principles in Zero-Cost Performance Predictors Neural Architecture Search” published by Silva et al., in 2023, evaluated the performance of several zero-cost performance predictors and proposed an algorithm to discover design principles automatically. However, its proposal is also limited to quantitative hyperparameters, while the present invention, in addition to automation for the discovery of quantitative hyperparameters, also comprises topological parameters.

Patent document US20210350203A1, entitled “Neural architecture search based optimized DNN model generation for execution of tasks in electronic device”, published by SAMSUNG ELECTRONICS CO., on Nov. 11, 2021, discloses a Neural Architecture Search (NAS) method that automatically designs DNNs optimized for different devices. The NAS process is accelerated by a meta-model hybrid ensemble, which learns to predict the performance of DNNs based on execution data comprising a variety of models on a variety of devices for a variety of learning tasks. US20210350203A1 further comprises a mechanism that automatically constrains the search with a truncation operation on the set of neural block choices. Once a DNN model is obtained, a deployment engine can replace unsupported operations with supported operations that approximate the original function for the specific device, and due to the replacement of operations, retrain the modified pre-trained model with the substituted operations. However, this method is designed to operate in the development phase of a DNN. In contrast, the present invention performs intelligent constraints on the search space based on automatically discovered design principles, and further performs search space architecture redesign, recycling, and refactoring in production environments in order to handle data and/or concept drifts automatically.

Patent document EP4163833A1, entitled “Deep neural network model design enhanced by real-time proxy evaluation feedback”, published by INTEL CORPORATION, on Apr. 12, 2023, describes a method in a model development environment that is enhanced by automatically generated performance predictors based on the learning task, in the domain of learning, target hardware configuration, and other user-supplied data. These performance predictors can be composed of other performance predictors, such as zero-cost performance predictors, which can be employed as features of the surrogate models generated with greater accuracy. As the user proposes and/or modifies a variety of machine learning model configurations, the invention provides real-time evaluation feedback based on performance predictors. The invention further comprises a Proxy Feedback Mechanism that operates in the background and can improve existing performance predictors by selecting user-supplied untrained models, and further using this training data to retrain the performance predictors with semi-supervised learning algorithms. However, performance predictors are employed during the development phase of DNNs. In contrast, the present invention employs performance predictors in order to monitor different causes of performance degradation in production environments.

Patent document U.S. Pat. No. 11,003,994B2, entitled “Evolutionary Architectures for Evolution of Deep Neural Networks”, published by SENTIENT TECH BARBADOS LIMITED on May 11, 2021, discloses a method for producing improved DNNs using a genetic algorithm (GA), through optimization of quantitative and topological hyperparameters. The proposed method aims to evolve DNN architectures, while the best models are collected to operate with production data. However, in the present invention the cooperation between NAS, training and production is orchestrated by a Performance Monitor module that detects different types of performance degradation and handles them with different automated procedures.

Patent document US2022027739A1, entitled “Search space exploration for deep learning”, published by International Business Machines Corporation, on Jan. 27, 2022, reveals a method capable of generating new search spaces with an evolutionary algorithm that applies mutations to the hyperparameters defined in the initial search space. Some random mutation operations can do cause a new NAS to be run in the new search space to select a new neural architecture. The present invention also runs a new NAS when the search space changes, however, instead of random mutation, the change is caused by detection of performance degradation based on new data in the production environment.

Patent document U.S. Pat. No. 11,544,561B2, entitled “Task-aware recommendation of hyperparameter configurations”, published by MICROSOFT on Jan. 3, 2023, presents a method that predicts the performance of neural networks on datasets by learning a distribution of the datasets and hyperparameter configurations. Additionally, a network of performance predictors is further applied to hyperparameter recommendation. However, this requires training, while the invention presented here does not. Furthermore, the discovered design principles are built to design search spaces automatically rather than individual neural networks.

As seen in other prior art documents, the success of NAS depends on a well-defined search space, otherwise the search process may get lost and produce suboptimal solutions. Many strategies have been proposed to limit the search space reasonably. For example, some best practices consist of organizing the architecture into building blocks, which are design patterns replicated along the network backbone (e.g. ResNet blocks, ResNext blocks, Inception blocks, etc.), limiting the network topology (e.g., linear chain of connected convolutions), restrictions on quantitative imposing hyperparameters (e.g., the number of filters must double after stride=2), and/or limiting the complexity of the network (e.g., FLOPs and number of parameters).

These restrictions on the search space are called “design principles” because they are expected to maximize the performance of networks when compared to unconstrained search space DNNs. However, defining design principles is heavily dependent on insights from machine learning engineers, which is a significant barrier in NAS automation.

Additionally, an MLOps pipeline automation does not necessarily handle data or concept drifts adequately, even if it operates in conjunction with a NAS system. The reason is that depending on the cause, different scenarios may require different responses, for example, retraining a DNN with recent production data, redesigning the network architecture and replacing obsolete models, or even redefining design principles and refactoring the entire structure of the neural network.

Therefore, the proper application of zero-cost performance predictors may also require monitoring changes in these deviations in order to ensure maximum efficiency and assertiveness.

### SUMMARY

A method of automatically optimizing a variety of neural network design principles in production environments, the method comprising: receiving a user request; checking whether there is new data; detecting obsolescence criteria based on: framework obsolescence; architectural obsolescence; and obsolescence of knowledge. The method may include automatically refactoring a model database including: based on the framework obsolescence being detected, searching for new design principles; based on the architectural obsolescence being detected, searching for new network architectures; based on the obsolescence of knowledge being detected, training and validating new deep neural networks; based on a number of validated deep neural networks being greater than a threshold, calculating performance predictors for each validated neural network.

### BRIEF DESCRIPTION OF THE DRAWINGS

The objects and advantages of the invention will become clearer through the following detailed description of the example and non-limiting drawings presented at the end of this document.

FIG. 1 presents an overview of the operation and application of the method of the present invention according to an embodiment.

FIG. 2 presents an example of a deep neural network architecture an exemplary embodiment of the present invention.

FIG. 3 shows an exemplary embodiment of the present invention.

FIG. 4 shows an exemplary embodiment of a method of the present invention.

FIG. 5 exemplifies performance degradation detection in production environments an exemplary embodiment of the present invention.

FIG. 6 exemplifies an assertiveness indicator measured as the area under the curve of the empirical distribution function an exemplary embodiment of the present invention.

### DETAILED DESCRIPTION

The operation of the proposed systems, as well as the methods for detecting and alerting performance degradation in real-time can be fully understood by reading the following description.

The present invention is related to the field of machine learning. Particularly, it refers to deep neural networks designed automatically by evolutionary algorithms (e.g. genetic algorithms) and trained with supervised learning systems (e.g. backpropagation algorithms), which are capable of automating complex productive tasks (e.g. processing of images and/or texts, classification and prediction). The present invention also relates to machine learning operations, which comprise a variety of methods designed to deploy and improve machine learning applications in production pipelines (e.g., automatic deployment of validated models, performance monitoring, continuous training with data recent models and/or automatic replacement of obsolete models).

The present invention describes a method that comprises a Modeling Environment together with a Production Environment capable of detecting different types of data and/or concept drifts, and responding automatically by recycling, redesigning and/or refactoring deprecated DNNs in production pipelines. The Modeling Environment comprises Design Principles Search module, a Neural Architecture Search module, and a Train and Validation module. The Production Environment comprises a User Request Processor module, a Performance Monitor module, and a Predictor Monitor module.

The Design Principles Search module automatically discovers design principles by following an iterative processes. This starts with a general, possibly infinite search space, and then generates a sample of random DNNs from the initial search space, estimates their performance, and formulates design principles by analyzing the hyperparameter distributions of the best DNNs. Preferably, the performance of DNNs is estimated with zero-cost performance predictors. After that, a new sample of random DNNs is generated from the new search space constrained by the design principles, and the process is repeated until it converges on a set of optimal design principles. This module analyzes quantitative and non-quantitative hyperparameters.

The Neural Architecture Search module automatically designs a DNN constrained by the discovered design principles. In a further embodiment, the neural architecture search module is a Genetic Algorithm.

In another embodiment, the Neural Architecture Search module is a Particle Swarm Optimization algorithm. Those skilled in the art will note that other optimization algorithms that accept restricted search spaces can be implemented as a Neural Architecture Search module for the same purpose. Preferably, the fitness function (or objective function) is calculated with zero-cost performance predictors.

The Train and Validation module performs supervised learning on a reference dataset for a specific task (e.g. classification, regression, prediction, etc.). Reference datasets can contain data from known public datasets and private data, which can come from user requests. This module partitions the benchmark dataset into a training dataset and a validation dataset. A machine learning algorithm (e.g., backpropagation) updates the DNN to minimize a loss function (e.g., cross-entropy) on the training dataset. When training is complete, the performance of the DNN is evaluated on the validation dataset, which comprises a variety of performance indicators (e.g. classification accuracy, latency, model size, etc.). If the DNN's performance is greater than or equal to an established baseline, it can be stored in the Validated Models database and can be employed to fulfill user requests.

The User Request Processor module instantiates a DNN from the database of validated models, processes user input, and responds accordingly. In one embodiment of this invention, the user makes requests via API calls. In another embodiment, the validated model is automatically downloaded to the user's device and executed locally. There are other possible embodiments where different interfaces are provided so that users can make requests to the machine learning application. When the user request is fulfilled, the user input data along with the corresponding DNN response can be delivered to the Performance Monitor so that it can perform its function.

The Performance Monitor module can store recent user data in a new benchmark dataset, or it can update another existing dataset. To detect data drift and/or concept drift, this module calculates statistics on old and new data, which includes a variety of indicators of knowledge obsolescence (e.g. when DNN validation performance decreases on new data), architectural obsolescence (e.g., when the distribution of predicted performance decreases on new data) and design obsolescence (e.g., when there is a change in design principles induced by new data). Preferably, architectural obsolescence indicators and design principles obsolescence indicators are computed with zero-cost performance predictors. This module can handle the different signs of obsolescence by retraining DNNs with new production data, a new Neural Architecture Search that will replace obsolete DNNs in production, and/or a Design Principles Search to refactor the entire framework.

The Predictor Monitor compares the current and previous versions of production datasets. If there is a significant change in the distribution of the data, this module can re-evaluate the correlation between the performance predicted by the zero-cost performance predictors and the performance measured by the train and validation module. If the correlation changes, the zero-cost performance predictors are reconfigured, promoting those with higher correlation and demoting those with lower correlation.

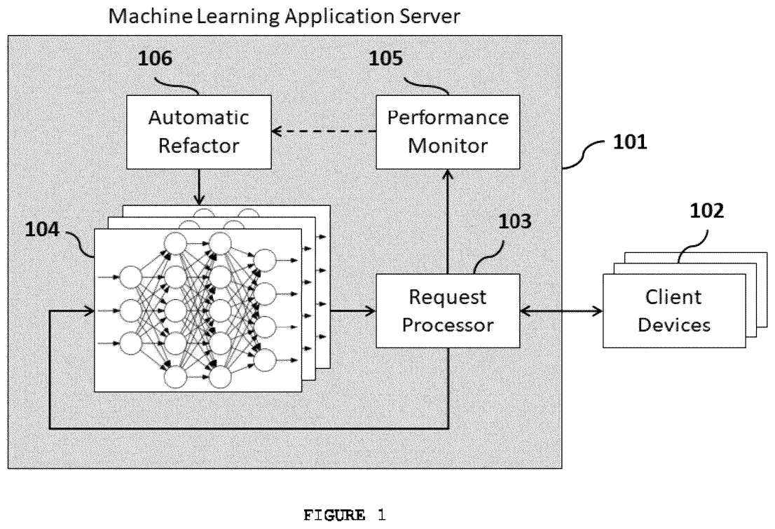

FIG. 1 discloses an embodiment of the system of this invention, which comprises a machine learning application server (101) capable of receiving user requests from client devices (102), processing and serving them (103) with provision from DNN (104). The performance of the models is continuously monitored (105) based on user input and DNN output. When a performance degradation is detected, the system automatically refactors the DNN in production (106). In this context, the term “refactor” means the adaptation of DNN to different scenarios of data and/or concept drifts.

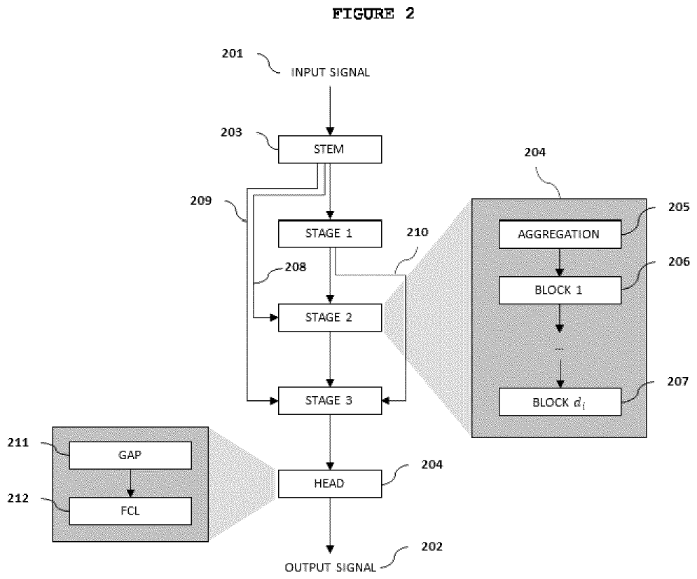

FIG. 2 reveals an exemplary DNN architecture that can be optimized by the system and method presented in the present invention. For example, the input signal (201) may be an RGB image, and the output signal (202) may be an image classification type (e.g., object recognition, facial expression, gender, etc.).

The STEM (203) is a learning unit composed of a 3×3 convolutional layer with w₀ filters of and stride=1. Preferably, all convolutions in this architecture are followed by batch normalization (BN) procedures and a rectified linear unit (ReLU). Then STEM is followed by a three-stage sequence. Each stage (204) comprises an aggregation function followed by a sequence of dᵢ blocks, for 1≤i≤3. The aggregation function (205) composes an aggregate signal by summing or concatenating the signals received from the previous learning units. For example, STAGE 2 aggregates the signals from STEM and STAGE 1. If there is only one input signal, the aggregation function can be ignored.

Each block within the stage is an aggregated residual transformation bottleneck block (ResNext) with wᵢ filters, gᵢ groups, and b; bottleneck ratio, for 1≤i≤3. The first block (206) computes its 3×3 convolution with stride=2 and a skip connection is replaced by a 1×1 convolution with stride=2. All other blocks have stride=1 and common skip connections.

The output signals from the STEM and the last block in each stage (207) may pass through a skip stage connection (SSC). For example, there are SSC from STEM to Stage 2 (208), from STEM to Stage 3 (209), and from Stage 1 to Stage 3 (210). Therefore, the aggregation function at each stage works as a feature fusion mechanism, by synthesizing all the features learned in the previous stages. An SSC is a convolution or a zeroize function. To ensure dimension compatibility, a k×k convolution SSC from STEM to stage i has W₍ᵢ₋₁₎ filters and stride=2\hat{ }(i−1) and an SSC from stage i to stage j has w₍ⱼ₋₁₎ filters and stride=2\hat{ }(j−i−1), the kernel size is set to k=stride+1, and the padding is adjusted accordingly. A zeroize function simply sets the signal to zero, which effectively disables this connection.

Finally, the HEAD is composed of a global average pool (211) followed by a fully connected layer (212), which performs image classification.

| Type | Hyperparameter | | Possible Values |
|---|---|---|---|
| Non- | STAGE 2: AGGREGATION | | sum, concatenate |
| Quantitative | STAGE 3: AGGREGATION | | sum, concatenate |
| | SSC: STEM, STAGE 2 | | zeroize, convolution |
| | SSC: STEM, STAGE 3 | | zeroize, convolution |
| | SSC: STAGE 1, STAGE 3 | | zeroize, convolution |
| Quantitative | STAGE 1: | BLOCKS | 1 ≤ d₁ |
| | | FILTERS | 1 ≤ w₁ |
| | | GROUPS | 1 ≤ g₁ ≤ w₁ |
| | | BOTTLENECK | 1 ≤ b₁ ≤ 4 |
| | | INDEX | |
| | STAGE 2: | BLOCKS | 1 ≤ d₂ |
| | | FILTERS | 1 ≤ w₂ |
| | | GROUPS | 1 ≤ g₂ ≤ w₂ |
| | | BOTTLENECK | 1 ≤ b₂ ≤ 4 |
| | | INDEX | |
| | STAGE 3: | BLOCKS | 1 ≤ d₃ |
| | | FILTERS | 1 ≤ w₃ |
| | | GROUPS | 1 ≤ g₃ ≤ w₃ |
| | | BOTTLENECK | 1 ≤ b₃ ≤ 4 |
| | | INDEX | |

Table 1 summarizes the 17 hyperparameters of an exemplary CNN architecture. Preferably, quantitative hyperparameters are limited by minimum and maximum values. Optimizing this architecture for a specific task is not a trivial task, as there are a large number of possible DNNs with the structure depicted in FIG. 2 and the hyperparameters in Table 1. The optimization module must be capable of optimizing both quantitative and non-quantitative hyperparameters. Furthermore, the present application must be able to adapt the hyperparameters to different data and/or concept drift scenarios.

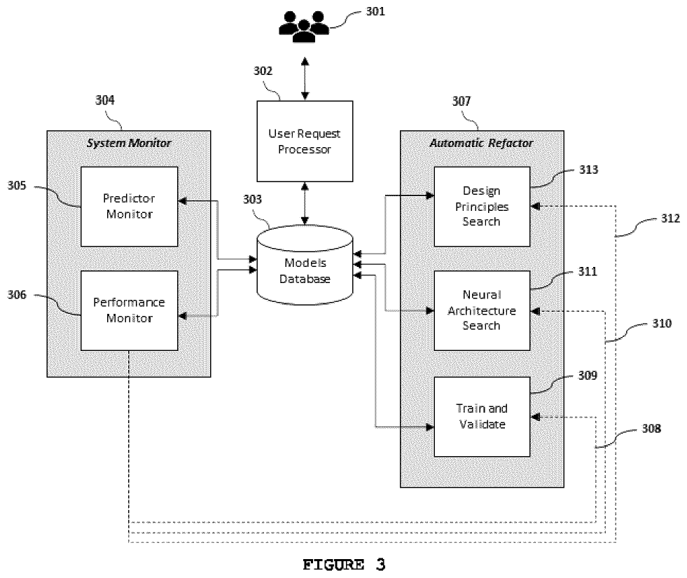

FIG. 3 reveals an exemplary embodiment of the system proposed for this invention. The user makes requests through client devices (301), which comprise computers, smartphones, tablets, and other computing devices. User requests are handled by the User Request Processor (302), which feeds the user input signal to a DNN in the Model Database (303), returning the output signal to the user and storing both the input and output signals in the production datasets located in the Model Database. In one embodiment, the user makes requests from a client device (e.g., a computer, a smartphone, etc.) via API calls over a secure network connection to a back-end application on a server.

The System Monitor (304), in turn, comprises the Predictor Monitor (305) and the Performance Monitor (306), which cooperate to detect concept drifts and/or data drifts efficiently and reacts accordingly by triggering Automatic Refactor (307). Depending on the performance degradation detected, the Performance Monitor may report a knowledge obsolescence signal (308), which is handled by the Train and Validation module (309), an architecture obsolescence signal (310), which is handled by the Neural Architecture Search module (311), and/or a framework obsolescence signal (312), which is handled by the Design Principles Search module (313).

Design principles are constraints on DNN hyperparameters that should maximize DNN performance. They can also be interpreted as constraints on the DNN search space. The design principles search module automatically discovers design principles with an iterative process until it converges on an optimal set.

It starts by defining the initial search space, which can be general and unrestricted. It then generates a random sample of DNNs within the defined initial search space. The sample size is an operational parameter that defines the random number of DNNs generated in this step. Next, it analyzes the hyperparameters of the best DNN using empirical bootstrap.

The empirical bootstrap is employed to resample the random DNNs with replacement and then to select the DNN with the highest score predicted by zero-cost performance predictors. The resample size is an operational parameter that defines the number of DNNs that will be resampled in each empirical bootstrap trial. Resampling trials is an operational parameter that defines the number of resampling and repeated selections in the empirical bootstrap.

For example, in one embodiment, the operating parameters may be set to sample size=1,000, resample size=250, and resampling=10,000. In this case, the empirical bootstrap will repeatedly resample 25% of the 1,000 random DNNs and select the best DNN from these 250 DNNs resampled. This procedure is repeated 10,000 times, which results in 10,000 examples of the best DNNs from that sample population. Then the design principles search module observes patterns in the hyperparameters of the best DNNs.

For quantitative hyperparameters, design principles are discovered by estimating confidence intervals (CI) with the best DNNs. For example, 95% CI can be estimated by selecting the 2.5th percentile as the lower limit and the 97.5th percentile as the upper limit.

For non-quantitative hyperparameters, design principles are discovered by determining an optimal subset of possible values. An operational parameter can be set to eliminate all possible values that occurred with a frequency below the specified value. For example, suppose a minimum threshold is set to 58, and for the SSC: STAGE 1, STAGE 3 function, the stage skip connection from STAGE 1 to STAGE 3, convolution occurred in 96% of the best DNNS and zeroize occurred in 4% of them. In this case, zeroize will be eliminated from this SSC.

Finally, if the discovered design principles are the same as the previous iteration, the process stops. Otherwise, it generates a new sample of random DNNs constrained by current design principles and proceeds to analyze the best models. The process repeats until it converges or reaches the maximum number of refinements of the design principles. Discovered design principles are stored in the Model Database.

The Design Principles Search module optimizes the search space, while the Neural Architecture Search module optimizes a DNN for specific learning tasks. In an exemplary embodiment, this module is a Genetic Algorithm (GA) comprising population initialization, mate selection, crossover, mutation, and environment selection operators. GA employs these operators to maximize a fitness function, which is an indicator of DNN performance. Preferably, the fitness function is a zero-cost performance predictor.

GA also comprises a coding scheme with a memory representation of quantitative and non-quantitative hyperparameters (chromosomes). In an exemplary embodiment, each chromosome X=(T,Q) is represented as a double strand comprising quantitative hyperparameters T=(t₁, . . . , tᵢ, . . . , t_{M}) and non-quantitative hyperparameters Q=(q₁, . . . , qᵢ, . . . , q_{N}).

GA further comprises a decoding scheme that creates a real DNN from a corresponding chromosome, so that there is a one-to-one correspondence between a chromosome and a DNN architecture. Because of this, here the term “population” can refer to a set of chromosomes and/or the corresponding set of DNN architectures.

The population initialization operator generates a random population of DNN whose hyperparameters are constrained by the design principles discovered by the Design Principles Search module. The initial population size can be limited by an operational parameter.

The mate selection operator chooses two chromosomes from the population that will generate offspring. The selection of the first parent chromosome is carried out with binary competition, which consists of randomly choosing two chromosomes and selecting the one with the highest fitness. The same procedure is repeated to select the second parent chromosome.

Given the two parents selected by the mate selection operator, the crossover operator generates two offspring with the following procedure. It generates a random crossover point in the ribbon of quantitative hyperparameters. Then, the first offspring will be defined with the initial genes of the first parent and the terminal genes of the second parent, while the second offspring will be defined with the initial genes of the second parent and the terminal genes of the first parent. A similar procedure is performed using non-quantitative hyperparameters.

The mutation operator changes the genes of an offspring. Preferably, an operational parameter will control the mutation probability. This operator changes the value of a gene by randomly selecting another value as long as they are within the limits of the discovered design principles.

After a certain number of generations of offspring, environmental selection chooses the chromosomes that will survive to the next generation. From the total number of parents and descendants, the operator chooses the survivors through semi-complete binary competition, in order to preserve the best individuals in each generation.

The GA continues to run until it converges, that is, as long as there is no significant improvement in fitness, or until a maximum number of fitness evaluations is reached. The architectures produced by the neural architecture search module are stored in the Model Database.

The Train and Validation module is responsible for training the DNN with training data and evaluating its performance with validation data. In an embodiment of the present application, this module trains the DNN with a standard gradient descent (GD) optimizer, which minimizes a predefined loss function by computing gradients and updating the DNN weights through backpropagation.

Its execution n is controlled by the following parameters: number of epochs, batch size, learning rate, weight decay, Nesterov moment and label smoothing. The learning rate scheduler changes the learning rate as a function of the current training epoch.

Before feeding the input signal during training, this module can apply data transformations (e.g. normalization, standardization, etc.) and data augmentations (e.g. pixel padding, random cropping, horizontal padding, etc.) to input signals.

When training is complete, this module evaluates the performance of the DNN on the validation dataset. It can calculate performance metrics such as classification error for classification tasks and root mean squared errors for regression tasks, for example. This module also calculates network complexities such as latency, number of FLOPs, model size, etc. The trained DNNs are stored in the Model Database along with their validation information.

If a DNN achieves a minimum baseline performance (as defined by experts) and a viable network complexity for the intended application, it is considered suitable for meeting production requests from client devices.

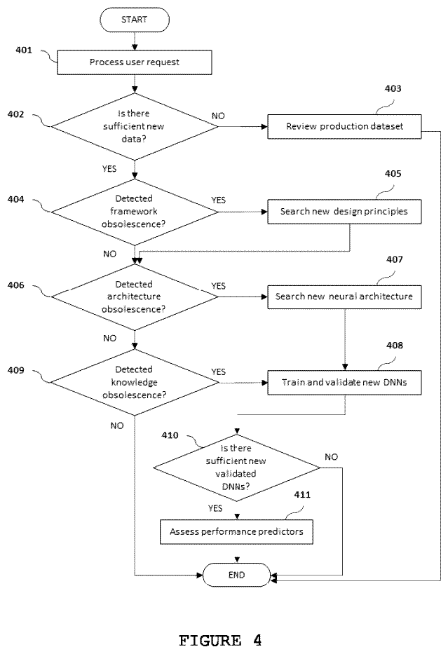

FIG. 4 discloses an exemplary embodiment of the proposed method of this invention. The data processed and stored by the User Request Processor (401) may be further audited and reviewed by experts in order to create a new production dataset with recent data. A minimum number of reviewed predictions may be predefined in the System Monitor. If the number of reviewed predictions is below the expected (402), the System Monitor may prompt the experts to review them (403).

The Performance Monitor module is a control tool that monitors a variety of indicators from the production DNNs and the production datasets. When there is a minimum number of reviewed predictions in the recent production dataset, this module may detect different types of performance degradation.

The Performance Monitor module observes assertiveness indicators, which are designed to estimate the overall distribution of predicted performance of populations of DNNs. It stores a sample of DNNs constrained by the design principles uncovered by the Design Principles Search module. This sample is referred to as the “observation set”. The size of the observation set may be predefined. Then, the performances of all DNNs in the observation set are predicted by zero-cost performance predictors with mini-batches of data from the recent production dataset.

If there is a significant change in the mean, standard deviation, coefficient of variation and/or other statistical parameters of predicted performance in the observation set, then the Performance Monitor module may report a framework obsolescence signal (404) that will be handled by the Design Principles Search module (405).

After that, the Performance Monitor checks if there is architecture degradation (406). If the hyperparameters of a DNN in production are not covered by the new design principles settings, or if there is a significant decrease in its predicted performance below a specified threshold, as measured by the zero-cost performance predictors with the recent production dataset, then an architecture obsolescence signal may be reported. This obsolescence signal will be handled by the Neural Architecture Search module (407), which will design a new architecture. In the sequel, the new architecture will be sent to Train and Validation module (408).

Else, if the validated performance decreases below a predefined threshold (409), this module will report a knowledge obsolescence signal that will be handled by the Train and Validation module in order to retrain the DNNs with the recent production dataset. For instance, suppose a DNN in production was validated with 95% accuracy in the old version of the validation dataset. However, after the audit of the recent production dataset, the model's performance decayed to 90% accuracy. In this case, the Performance Monitor module may raise a knowledge obsolescence signal in order to retrain the DNN with the recent data.

The Predictor Monitor module is responsible for estimating the correlation between the zero-cost performance predictors and the actual validation performance measured after training. In one embodiment, the performance predictors are those pointed out in Abdelfattah, Mohamed S., et al. “Zero-Cost Proxies for Lightweight NAS” International Conference on Learning Representations (2021):
grad_norm: defined as the Euclidean norm of the gradients.
snip: a sensitivity score to detect the relevant connections of a neural network at its initialization.
grasp: a sensitivity score to preserve the gradient flow.
synflow: it aims at assessing the effect on loss when several parameters are removed from a neural network.
fisher: it aims at assessing the effect on loss when activation channels (features maps) of a network are removed.
jacov: it is a function of the covariance of the Jacobian matrix, which computes the gradients of output signals in relation to the input signals.
logdet: it scores a neural network architecture according to its activation function level along the layers.

Preferably, the performance predictors are computed on just one mini-batch of training. In other embodiments, other performance predictors might be considered by the Predictor Monitor module. Based on the estimated correlation, at least one performance predictor will be selected from the list and then be used as fitness function in the Design Principles Search module and in the Neural Architecture Search module.

If the number of validated models is higher than a predefined threshold (410), this module computes the rank correlation between the predicted performance and the validated from all fully trained DNNs with recent production data, which may include both high-performing DNNs and low-performing DNNs that remained below the established threshold. Although these low-performing DNNs are not suitable to serve production requests, they are useful to observe changes in rank correlations of performance predictors. Then, this module promotes the zero-cost performance predictors with higher rank correlations and demotes the ones with lower rank correlations (411).

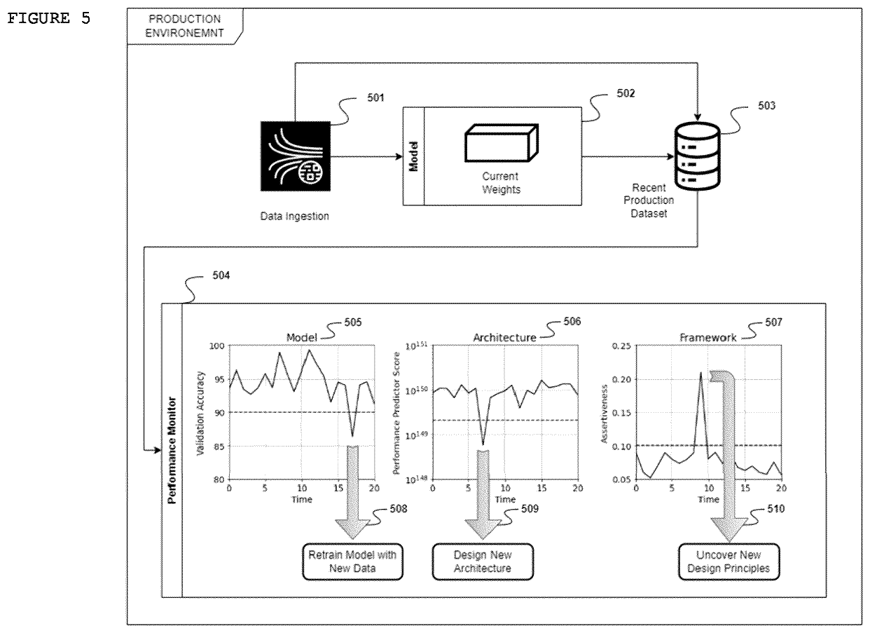

FIG. 5 shows examples of performance degradation detection in the production environment. Requests from the user are handled by a data ingestion mechanism (501), that feeds the input data to the appropriate validated model in production (502). Both the user's input and the model's output are stored in the recent production dataset (503).

Since new data are continuously being ingested into the dataset, it is possible to monitor changes in the model's performance over time. The Performance Monitor module (504) computes at least one performance indicator for models (505), architectures (506), and design principles (507) using recent data and compares them with predefined performance thresholds.

In order to monitor the model's performance (505), at least one performance threshold may be set. For instance, a performance threshold may be set as 90% minimum validation accuracy (508). The Performance Monitor module keeps a record of the validation accuracy in the most recent data. If at a certain time index the validation accuracy decreases below 90%, then a knowledge degradation signal will be reported (308), which will trigger the Train and Validation module (309) to automatically retrain the model with the recent data.

In other embodiments, other performance indicators may be monitored by the Performance Monitor module such as, but not limited to, efficiency, latency, energy consumption, cost, and others. In other embodiments, the Performance Monitor module may monitor more than one performance indicator in order to monitor the models' performance degradation over time.

In order to monitor the architecture's performance (506), at least one performance predictor score threshold may be defined. Preferably, the performance predictor score is a zero-cost performance predictor. For instance, the performance predictor score threshold may be set as 2.1×10¹⁴⁹ minimum synflow score (509).

The Performance Monitor module keeps a record of the architecture's synflow score on the most recent data. If at a certain time index the synflow decreases below 2.1×10¹⁴⁹, then an architecture degradation signal will be reported (310), which will trigger the Neural Architecture Search module (311) to design a new architecture with the recent data.

Furthermore, the new architecture will be trained by the Train and Validation module (309) with the recent data. In other embodiments, other performance predictor scores may be monitored by the Performance Monitor module such as, but not limited to grasp, snip, logdet, and others. In other embodiments, the Performance Monitor module may monitor more than one performance indicator in order to monitor the architectures' obsolescence.

In order to monitor the framework's performance (507), at least one assertiveness indicator threshold may be defined. An assertiveness indicator measures the quality of a certain set of design principles by monitoring the overall score distribution of DNN architectures within the search space defined by the design principles.

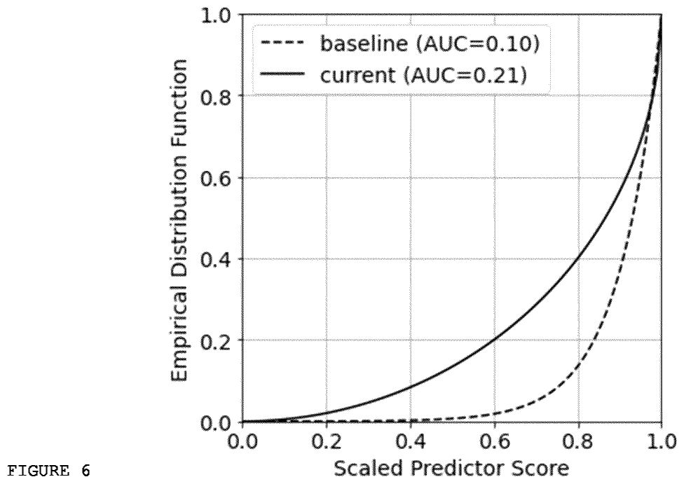

FIG. 6 shows an exemplary assertiveness indicator defined as the area under the curve (AUC) of the empirical distribution function (EDF). The AUC EDF indicator can be computed as follows. A random sample of DNN architectures is generated within the search space constrained by the design principles uncovered by the Design Principles Search module.

In the context of the Performance Monitor module, this random sample of DNN architectures is referred to as the “observation set”. Then, at least one performance predictor score is computed for all DNN architectures. Preferably, the performance predictor score is a zero-cost performance predictor.

In the sequel, the scores are rescaled with min-max normalization, which is computed as follows:

$$scaled\_score = \frac{score - min\_score}{max\_score - min\_score}$$

where “score” is the performance predictor score of a DNN architecture, “min score” is the minimum score in the observation set, “max score” is the maximum score in the observation set, and “scaled score” is the score normalized with min-max normalization. The scaled scores are plotted on the x-axis in FIG. 6. In the sequel, the EDF is computed as a function of the scaled score as follows:

$$EDF ( x ) = \frac{\vert \{ s ∈ O : s \leq x \} \vert}{\vert \{ s ∈ O \} \vert}$$

where “x” is a scaled score threshold, s∈0 is a scaled score of a network from the observation set, {s ∈ 0: s≤x} is the subset of all scaled scores that are less or equal a given scaled score threshold “x”, and “|·|” is the number of elements in the subset.

That is, the EDF (x) function computes the proportion of DNN architectures that have a scaled score less than or equal to the scaled score threshold “x”. The EDF (x) function is plotted in the y-axis in FIG. 6.

Finally, the AUC EDF indicator is defined as follows:

$$AUC EDF = {\int }_{0}^{1} EDF ( x ) dx$$

which can be computed numerically with the trapezoidal rule.

FIG. 6 shows the EDFs of two distributions of scaled a baseline distribution and a current distribution. The AUC of the baseline EDF is 0.10, whereas the AUC of the current EDF is 0.21. The comparison of the two EDFs reveals that the current distribution is worse than the baseline distribution because there was an increase in the probability of DNN architectures with lower scaled scores.

In this case, if the assertiveness indicator is set as 0.10 minimum AUC EDF (510), then a framework degradation signal will be reported (312), which will trigger the Design Principles Search module (313) to redesign the search space by uncovering new design principles automatically with the recent data.

Furthermore, if the model in production does not belong to the new search space, the Neural Architecture Search module (311) will design a new architecture with the recent data and the new architecture will be trained by the Train and Validation module (309) with the recent data.

Although the present invention has been described in connection with certain preferred embodiments, it should be understood that it is not intended to limit the disclosure to those particular embodiments. Rather, it is intended to cover all alternatives, modifications and equivalents possible within the spirit and scope of the disclosure as defined by the appended claims.

Although we disclosed an exemplary search space containing CNNs such as those in FIG. 2, there are other embodiments that optimize other DNN architectures such as Transformers, RNNs, FCNN, etc. It will be apparent to those skilled in the art that the disclosed method and system are applicable to any other possible design space, and it is capable of optimizing all types of quantitative and non-quantitative hyperparameters.

In other embodiments of the present invention, the Design Principles Search module may limit the complexity of the DNNs generated in the random samples. The minimum and/or maximum acceptable values might be defined for FLOPs, number of parameters, latency, and others. DNNs with complexities outside the specified range will not be included in the random samples.

In other embodiments of the present invention, the Design Principles Search module may predict the DNNs performance with any other performance predictors such as, but not limited to, training with reduced epochs, training with reduced dataset, training surrogate models, and others.

Although the present invention discloses an exemplary Design Principles Search module that searches for optimum subsets of hyperparameters, in other embodiments, other representations are possible. For instance, relations between different hyperparameters (e.g., dᵢ≥dᵢ₋₁, bᵢ=bᵢ₋₁) or functions between different hyperparameters (e.g., wᵢ=ƒ(Wᵢ₋₁), where ƒ(·) can be any function). This further comprises relations and functions between any number and/or any types of hyperparameters.

In other embodiments of the present invention, the Neural Architecture Search module might be implemented as Hill Climbing, Evolution Strategy, Particle Swarm Optimization, or other algorithms. It will be apparent to those skilled in the art that the disclosed technology could be embodied with any other search algorithm that can perform optimization constrained by the uncovered design principles.

In other embodiments of the present invention, the Neural Architecture Search module may predict the DNNs performance with other performance predictors such as, but not limited to, training with reduced epochs, training with reduced dataset, training surrogate models, and others.

In other embodiments of the present invention, the User Request Processor module is deployed into the client devices, it downloads the DNNs and processes requests locally.

In other embodiments of the present invention, the Request Processor module may require the user's consent to upload their data into the production dataset on the server and may delete it upon the user's request.

In other embodiments of the present invention, the obsolescence signals for knowledge, architecture and/or framework may be reported and handled in parallel by the corresponding modules.

In other embodiments of the present invention, the framework obsolescence signal may be reported when there is a significant change in the distribution of zero-cost performance predictors in the observation set concerning old and new production datasets. This change may be measured as Kullback-Leibler divergence, Hellinger distance or any other statistical distance between the two distributions.

In other embodiments of the present invention, the invention disclosed herein might cover DNNs in a variety of settings and applications. For instance, it may refactor DNNs in operation at, but not limited to electronic systems composed by one or more of these components: a central processing unit (CPU), arithmetic logic unit (ALU), floating-point unit (FPU), graphics processing unit (GPU), tensor processing unit (TPU), neural processing unit (NPU), AI accelerator, primary memory (RAM-random access memory, SRAM), secondary memory (such as, but not limited to hard disk, flash memory, solid-state drive, tape, and others. For instance, computers, notebooks, portable microcomputers, single body computers, tablets, e-book readers, cellphones, smartphones, smart wearable devices (smart watches, smart bands, smart glasses, head set with virtual reality and/or augmented reality, earphones, headphones), supercomputers, quantum computers, televisions (TV), smart TVs, smart houses, domotics/home automation, refrigerators, fridges, cleaning robots, microwave ovens, stoves, toilets, and others, autonomous, semiautonomous, manual vehicles and/or remotely controlled machines such as, but not limited to autonomous cars, drones, unmanned aerial vehicles, airplanes, harvesters, tractors, trucks, busses, trains, ships, submarines, robots, satellites, rockets, scooters, motorcycles, bikes, and others.

The state-of-the-art recommender systems are implemented with DNNs trained to predict the users' preference based on big datasets of users' interactions and/or purchases. Such preferences might change drastically and suddenly. Therefore, the invention disclosed herein can monitor and detect data drifts and/or concept drifts and automatically refactor DNNs in challenging scenarios of recommender systems, such as, but not limited to product recommendation in e-commerce websites, content recommendation in social networks, movie recommendation in streaming providers, automatic advertisement suggestions, and others.

Regarding the current context in retailing, one can consider the improvement of customer experience as an optimization process that comprises dynamic data from different sources and different natures, i.e., continuously subject to changes. Once AI models are part of this environment covering tasks such as gender and emotion recognition, age prediction, product or promotion recommendations, and customized experience according to place, region, store, or country, the scope of this patent proposal meets this use case regarding the necessity to ensure the performance of these models in acceptable levels and/or providing them a refactor property when detecting changes or models' performance degradation.

The use of Large Language Models (LLMs) is present in several applications currently. Although a bunch of pre-trained models with specific purposes are available, continuous learning and updates became mandatory for them in fact. From this context, the scope of this patent proposal meets this use case regarding the performance monitor module in order to detect model degradation or new input patterns on prompts to retrain models or ask for new ones. This invention is also applicable to other applications of generative AI such as, but not limited to automatic image generation, video generation, audio, music and speech generation, smells, tastes, haptic stimuli, and others.

In industrial plants, the scheduling and allocation of resources to attend production orders is a dynamic process that comprises several input variables. Oftentimes, those actions are defined by process agents comprising subjective criteria.

In this sense, the use of artificial intelligence models and/or optimization algorithms may significantly contribute to this task. From this context, the scope of this patent proposal meets this use case regarding recommender systems. One can extend the model application to process production orders and provide an optimal data-driven schedule dynamically comprising objective criteria such as order volume, headcount, deadline, and/or operational costs, but not limited to. A seasonality analysis can also be covered by pattern recognition and/or trend analysis on production orders data aiming at using historical data to provide insights about the necessity of improvements or increases in production capacity.

DNNs can be trained to predict asset prices based on historical data and current stock prices and to create buy and sell orders automatically for stocks, exchange-traded funds, stock options, future contracts, foreign currency, cryptocurrencies, and commodities such as, but not limited to oil, gold, lumber, natural gas, cotton, cattle, soy, coffee, and others. This a dynamic environment subject to continuous and/or abrupt changes, which is suitable to the invention disclosed herein to refactor DNNs for forecasting and decision-making models.

The present invention can be used for humans, animals, and plants wellness and healthcare applications by capturing and analysis their health data, predicting the impact of their current lifestyle and simulating their future health state. These includes analyzing, detecting, predicting, treating and healing health conditions in skin, finger, wrist, head, eye, nose, month, chin, breast, belly, hip, thigh, heel, ankle, toe, foot, knee, calf, waist, neck, upper arm, cheek, elbow, forearm, hand, arm, tooth, ear, brain, heart, spleen, stomach, intestines, male and female reproductive system, bladder, pancreas, kidneys, liver, lungs, thyroid, spine, muscle, circulatory system, respiratory system, digestive system, excretory system, immune system, muscular system, integumentary system, skeletal system, endocrine system, nervous system, left and right visual fields, cornea, retina, optic nerve, optic chiasma, lateral geniculate nucleus, primary visual cortex, frontal lobe, temporal lobe, lateral geniculate body, occipital lobe, visual cortex, optical radiation, optic tract, optic chiasm, optic nerve. The invention can analyze, detect, predict, treat and heal health conditions related to dementia, flu-like symptoms, fatigue, eating problems, tongue trouble, month ulcers, heart strain, respiratory infection, diarrhea, aches and pains, shingles, itchiness, immune system, skin sores, bumpy skin, kidney damage, cough, neuropathy, anxiety and depression, and stress. Sensors, actuators, and transductors for wellness and healthcare.

The present invention can be used for synthetic and natural drug discovery and development, drug repurposing, improving pharmaceutical productivity, clinical trials, and drug distribution.

The present invention can be used for automated software engineering, automatic requirements summarization, code generation, code documentation, risk analysis, automatic bug detection, classification, and correction, debugging, test case generation, automatic coding and execution of test routines, automatic test scheduling, and others.

The present invention can be used for other applications where data and concept drifts might occur drastically and/or frequently such as those that involves environmental changes, climate changes, biological changes, environment governance, economic changes, human preferences, and decision making in a fast-changing dynamic environments.

What is claimed is:

1. A method of automatically optimizing a variety of neural network design principles in production environments, the method comprising:
receiving a user request;
checking whether there is new data;
detecting obsolescence criteria based on:
framework obsolescence;
architectural obsolescence; and
obsolescence of knowledge,
automatically refactoring a model database including:
based on the framework obsolescence being detected, searching for new design principles;
based on the architectural obsolescence being detected, searching for new network architectures;
based on the obsolescence of knowledge being detected, training and validating new deep neural networks;
based on a number of validated deep neural networks being greater than a threshold, calculating performance predictors for each validated neural network.

2. The method as in claim 1, wherein the user request is a model search signal sent by a user.

3. The method as in claim 1, wherein the searching for the new design principles comprises:
defining an initial search space;
generating a random sample of Deep Neural Networks (DNN) (DNNs) within the defined initial search space;
analyzing hyperparameters of best DNNs using empirical bootstrap,
wherein the empirical bootstrap resamples random DNNs with replacement and selects a DNN with a highest score predicted by zero-cost performance predictors.

4. The method as in claim 3, wherein a resampling size is an operational parameter that defines a number of DNNs that will be resampled in each empirical bootstrap attempt.

5. The method as in claim 1, wherein the neural network design principles are divided between:
design principles relating to quantitative hyperparameters, including a number of neurons, a number of layers, a number of filters; and
design principles relating to non-quantitative hyperparameters including types of learning units, types of blocks and/or topological interconnections between the types of learning units, types of activation functions.

6. The method as in claim 1, wherein an empirical distribution function (EDF) is computed as a function of a scaled score, as follows:
$$EDF ( x ) = \frac{\vert \{ s ∈ O : s \leq x \} \vert}{\vert \{ s ∈ O \} \vert}$$
where “x” is a scaled score threshold, “s∈0” is a scaled score of a network from an observation set, {s ∈ 0: s≤x}″ is a subset of all scaled scores that are less than or equal a given scaled score threshold “x”, and “|·|” is a number of elements in the subset.

7. The method as in claim 1, wherein an area under a curve (AUC) EDF indicator is defined as follows:
AUC EDF=∫₀¹EDF(x)dx,
wherein the AUC EDF indicator is computed numerically with a trapezoidal rule.

8. A system of automatically optimizing a variety of neural network design principles in production environments, the system comprising:
client devices; and
a machine learning application server enabled to receive user requests from client devices,
wherein the machine learning application server comprises:
a system monitor comprising a Predictor Monitor and a Performance Monitor, which cooperate to detect concept drifts and/or data drifts efficiently and react accordingly by triggering Automatic Refactor; and
an Automatic Refactor, comprising a design principles search module, a neural architecture search module and a train and validation module;
a models database; and
a user request processor.

9. The system as in claim 8, wherein depending on a performance degradation detected, the Performance Monitor reports a knowledge obsolescence signal, which is handled by the train and validation module, an architecture obsolescence signal, which is handled by the neural architecture search module, and/or a framework obsolescence signal, which is handled by the design principles search module.

10. The system as in claim 8, wherein the Neural Architecture Search module is implemented as Genetic Algorithm, Hill Climbing, Evolution Strategy, Particle Swarm Optimization, or other algorithms.

11. The system as in claim 8, wherein the Neural Architecture Search module is enabled to predict performance of DNNs with other performance predictors including training with reduced epochs, training with reduced dataset, training surrogate models.
